(19) United States
(12) Patent Application Publication
(10) Pub. No.: US 2023/0352924 A1
(43) Pub. Date: Nov. 2, 2023

(54) ELECTRICAL WIRE HOUSING

(71) Applicant: Nielson Product Development, LLC, Hurricane, UT (US)

(72) Inventors: Scott Nielson, Hurricane, UT (US); SHANE JONES, Ivins, UT (US); MICK MEHLMAUER, Kula, HI (US); BRADLEY SHELTON, Ivins, UT (US)

(73) Assignee: Nielson Product Development, LLC, Hurricane, UT (US)

(21) Appl. No.: 18/298,969

(22) Filed: Apr. 11, 2023

Related U.S. Application Data
(60) Provisional application No. 63/329,957, filed on Apr. 12, 2022.

(51) Int. Cl. H02G 15/115; H02G 15/013

(52) U.S. Cl. CPC H02G 15/115; H02G 15/013

(57) ABSTRACT

An electrical wire housing includes a base, four sidewalls, and a lid, wherein at least two of the four sidewalls each have one or more apertures for receiving wires therethrough. In some examples, the apertures receive flexible members each having a slit therein, the slit designed to receive wires. The flexible members may each feature a first and second series of protrusions that create a water-resistant seal and secure the wires in place. The flexible members enable wires to be spliced outside of the electrical wire housing and thereafter placed within the electrical wire housing without decoupling the wires.

### CROSS-REFERENCE TO RELATED APPLICATIONS

This application claims the benefit of U.S. Provisional Application Ser. No. 63/329,957, filed on Apr. 12, 2022, which is incorporated herein by reference.

### TECHNICAL FIELD

The present disclosure relates to an electrical wire housing, also referred to as a junction box. In particular, the present disclosure relates to an electrical wire housing having a hinged lid with flexible members for receiving and securing wires within the electrical wire housing.

### BACKGROUND

Junction boxes are enclosures that protect electrical connections, such as spliced wires, from environmental conditions and accidental contact with people. These enclosures safeguard against electrocution and fires by containing any sparks that may occur during a short circuit. While junction boxes in the art vary in sizes and dimensions, each requires wires to be fed through one or more ports on the back or side of the junction box. As a result of this limited placement, the wires must be fed into the junction box prior to the connection or splice being made. These placements can make proper slicing more difficult to complete, as excess wire must be pulled through the ports, the wires spliced, and the remaining wire subsequently coiled within the junction box.

Moreover, if wires were previously spliced and not protected within a junction box, a user would first have to decouple the wires, feed them through the junction box, and then reconnect them. With wires that were previously spliced, there may not be sufficient length to pull them through the junction box and reconnect them. As a result, many wires are left outside of junction boxes, some of which are protected only with wire nuts or electrical tape, neither of which is safe. When installing junction boxes, the user must also select the right enclosure having sufficient load ratings for the applicable electronics or fixtures, thereby complying with industry standards and building codes.

Accordingly, there is a need for a junction box that allows for wires to be connected either inside or outside of the enclosure and thereafter safely secured within the housing. The present disclosure solves these problems and others.

### SUMMARY OF EXAMPLE EMBODIMENTS

In some embodiments, an electrical wire housing comprises a base, four sidewalls, and a lid, wherein at least two of the four sidewalls each comprise one or more apertures for receiving wires therethrough. The electrical wire housing may further comprise flexible members, each having a slit therein, wherein the flexible members are removably couplable to the one or more apertures. The flexible members may each comprise a first series of flexible protrusions opposite a second series of flexible protrusions, creating a water-resistant seal.

In some embodiments, the electrical wire housing comprises threaded couplers, couplable to the apertures and configured to receive wires. The threaded couplers may comprise a male end and female end with a gasket therebetween. The threaded couplers enable wires to be spliced outside of the electrical wire housing and thereafter placed within the electrical wire housing without decoupling the wires.

### BRIEF DESCRIPTION OF THE DRAWINGS

FIG. 1 illustrates an exploded top perspective view of an electrical wire housing;

FIG. 2 illustrates a top perspective view of an electrical wire housing with the lid open;

FIG. 3 illustrates a top perspective view of an electrical wire housing with the lid closed;

FIG. 4 illustrates an exploded top perspective view of an electrical wire housing with threaded couplers;

FIG. 5 illustrates a top perspective view of an electrical wire housing with the lid open;

FIG. 6 illustrates a top perspective view of an electrical wire housing with the lid closed;

FIG. 7 illustrates a top, front perspective view of a flexible member of an electrical wire housing;

FIG. 8 illustrates a front elevation view of a flexible member of an electrical wire housing;

FIG. 9 illustrates a rear elevation view of a flexible member of an electrical wire housing;

FIG. 10 illustrates a top plan view of a flexible member of an electrical wire housing;

FIG. 11 illustrates a bottom plan view of a flexible member of an electrical wire housing;

FIG. 12 illustrates a side perspective view of a first member and a second member of an electrical wire housing;

FIG. 13 illustrates a top, side perspective view of an electrical wire housing with the flexible members decoupled;

FIG. 14 illustrates a top plan view of the interior of an open electrical wire housing;

FIG. 15 illustrates a bottom plan view of the exterior of an electrical wire housing;

FIG. 16 illustrates a top, left side perspective view of an electrical wire housing with the lid closed;

FIG. 17 illustrates a top, right side perspective view of an electrical wire housing with the lid closed; and

FIG. 18 illustrates a top plan view of an electrical wire housing with the lid closed.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

As previously discussed, there is a need for a junction box that enables wires to be connected either inside or outside of the enclosure and that allows for pre-spliced wires to be safely secured inside the enclosure. The electrical wire housing disclosed herein solves these problems and others.

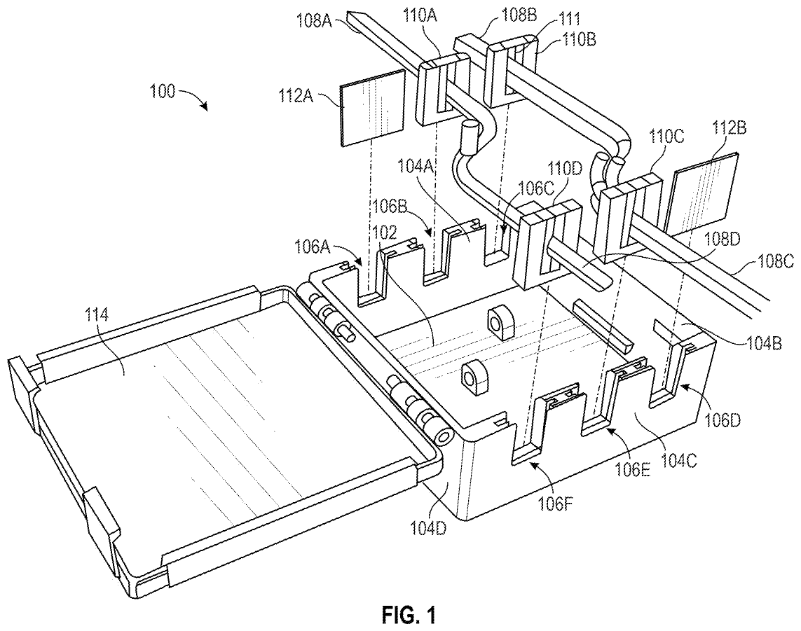

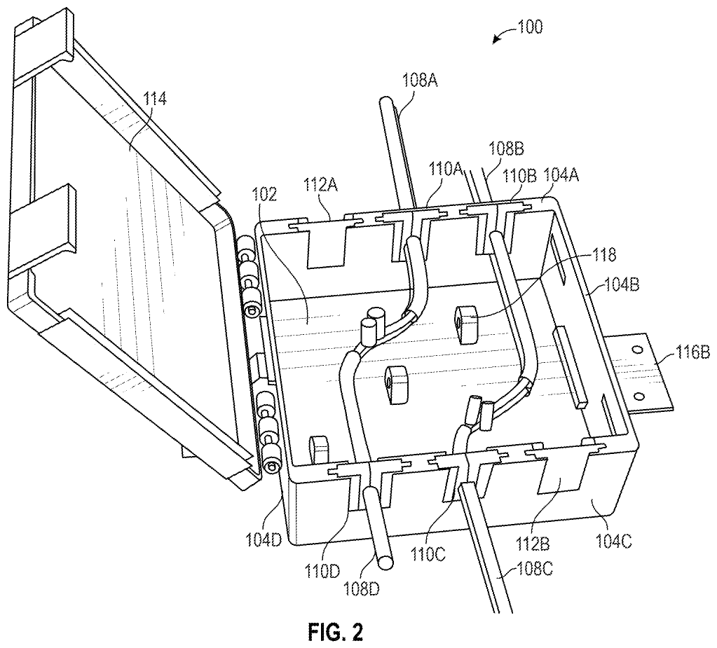

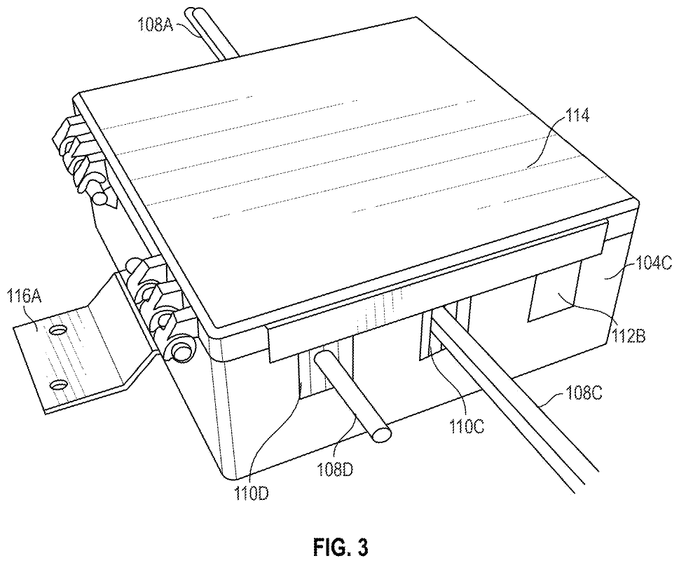

Referring now to FIGS. 1-3, in some embodiments, an electrical wire housing 100 comprises a base 102 and four sidewalls 104A-D, wherein at least two sidewalls (e.g., 104A, 104C) each comprise one or more apertures 106A-F for receiving wires 108A-D therethrough. The electrical wire housing 100 may comprise steel, polycarbonate, aluminum, plastics, or alternative metals and polymers based on indoor or outdoor use. As shown, though without limitation, the at least two sidewalls (e.g., 104A, 104C) may be opposite one another to enable the wires 108A-D to pass straight through the electrical wire housing 100, or alternatively may be oblique to one another to enable the wires 108A-D to enter the electrical wire housing 100 in one direction and exit at another. The apertures 106A-F may originate at a center of the sidewalls 104A-D and extend to the edge of the sidewalls 104A-D such that the apertures 106A-F are open on at least one side, forming a slot or groove.

The electrical wire housing 100 may further comprise flexible members 110A-D, each having a slit 111 therein, wherein the flexible members 110A-D are removably couplable to the apertures 106A-F. The flexible members 110A-D may comprise silicone, rubber, polyethylene, alternative polymers, related sealants, or combinations thereof that resist water from entering the electrical wire housing 100. The slit 111 is configured to receive wires 108A-D. In practice, the flexible members 110A-D may be inserted into the apertures 106A-F, respectively, and locked in place by compression fit, interlocking closures, adhesives, magnets, or other fastening mechanisms. In other words, the edges of the slit 111 abut one another such that no gap is present.

For example, as shown, the wires 108A-D may be seated in the slit 111 of the flexible members 110A-D. Speaking functionally, the flexible members 110A-D help to close or seal off an interior of the electrical wire housing 100 while the slit 111 maintains the wires 108A-D securely fastened against unwanted movement. As shown, the flexible members 110A-D are removable and may be positioned along the sidewalls 104A-D and placed in the appropriate apertures 106A-F as desired by a user, according to the circumstances of the electrical work being performed.

It will be appreciated that all apertures 106A-F may comprise flexible members 110A-D having slits 111, should a user desire to have three wire splices. However, for applications requiring fewer than three splices, a user may use position or more aperture shields 112A-B in the apertures 106A-F that are unused. For example, as shown in FIGS. 1-3, an aperture shield 112A may be placed in aperture 106A, and another aperture shield 112B may be placed in aperture 106D. Flexible members 110A-D are then received in apertures 106B, 106C, 106E, and 106F, respectively.

In this manner, a user may electrically couple the wires 108A-D (i.e., splice), then press the wires 108A-D into the respective flexible members 110A-D via slits 111, where the spliced connections are now enclosable within the electrical wire housing 100. The wire splices may be made according to traditional procedures known in the art using wire crimpers, shrink tubes, heat guns, terminal connectors, electrical tape, and other electrical tools and accessories. The engagement of a combination of flexible members 110A-D and aperture shields 112A-B within the apertures 106A-F seals all openings into the electrical wire housing 100 creating a water-resistant enclosure protected from outside elements.

In some embodiments, one or more of the wires 108A-D may have been previously connected in a house or other building structure, and simply covered with electrical tape or wire nuts. A user may easily place these existing wire connections within the electrical wire housing 100 without needing to first decouple the wires. Instead, a user can simply press the wires 108A-D into the appropriate slit 111 of each of the respective flexible members 110A-D. It will be appreciated that the present invention overcomes the prior art, which cannot secure wire connections in a housing (e.g., junction box) without first de-coupling the wires and feeding them through a port on the side of the housing.

The electrical wire housing 100, in some embodiments, further comprises a lid 114, which may be hingedly coupled to a respective sidewall 104A-D. The electrical wire housing 100 may further comprise one or more brackets 116A-B to secure the electrical wire housing 100 to a structure or surface.

The electrical wire housing 100 may further comprise wire securing protrusions 118 configured to secure the wires 108A-D to the base 102 of the housing 100. The wire securing protrusions 118 may comprise loops, as shown, or alternatively comprise grooves, hooks, or other fastening mechanisms that engage and secure the wires 108A-D. It will be appreciated that while the electrical wire housing 100 shown contemplates the creation of three wire connections spliced from up to six wires through the six apertures 106A-F, the electrical wire housing 100 may comprise more or less apertures 106A-F to fit a user's needs.

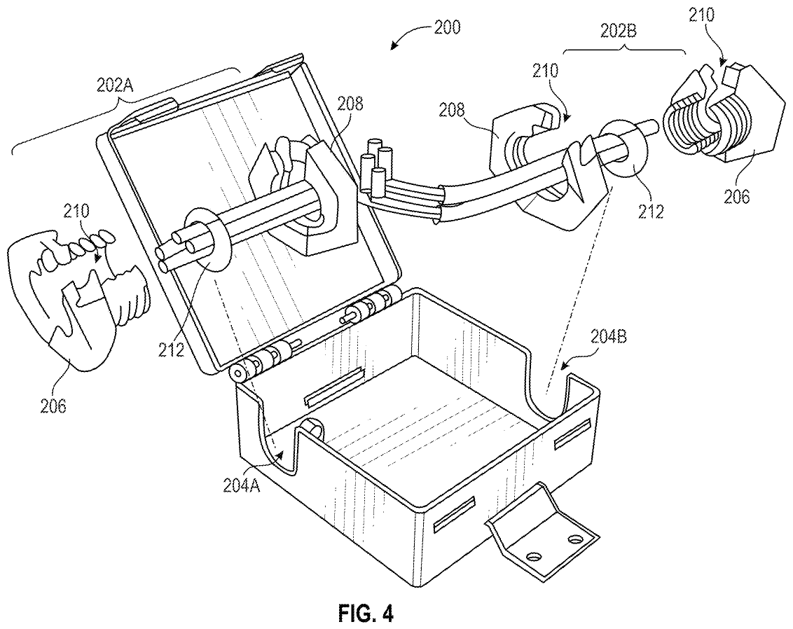

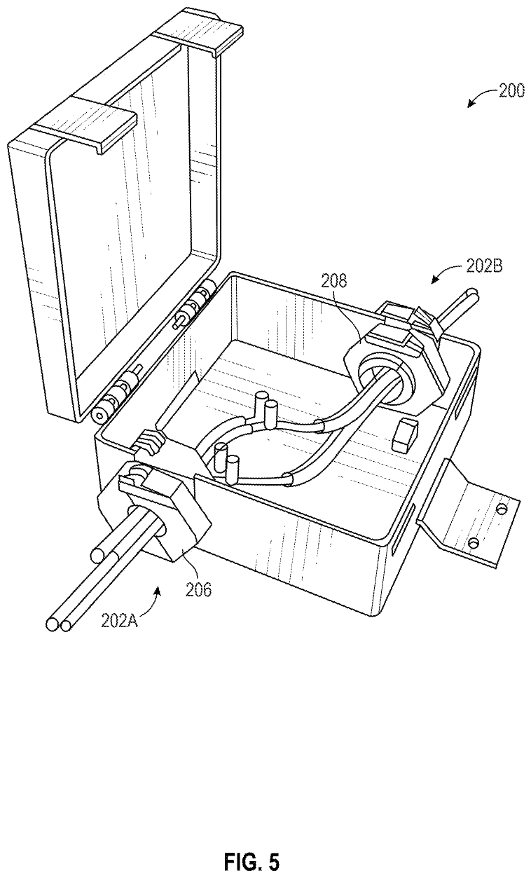

Referring now to FIGS. 4-6, in some embodiments, an electrical wire housing 200 may comprise threaded couplers 202A-B that are receivable within apertures 204A-B. Each of the threaded couplers 202A-B may comprise a male end 206 couplable to a female end 208. Each male end 206 and female end 208 may comprise a slit 210. The slit 210 enables interlocking ends of each male end 206 and female end 208 to open when pushed apart and thereafter close when pushed together. Speaking functionally, a user would place a wire into one of the threaded couplers 202A-B via the slit 210 in each male end 206 and female end 208, place the threaded couplers 202A-B in their respective aperture 204A-B, and then thread the male and female ends 206, 208 to each other, securing the threaded coupler to the respective aperture 204A-B via the sidewalls of the electrical wire housing 200. As a result, a user may place pre-spliced wires within the electrical wire housing 200, making the process easier and safer for a user. The threaded couplers 202A-B may each further comprise a gasket 212 to strengthen the seal between the male end 206 and the female end 208 of each of the threaded couplers 202A-B. It will be appreciated that the gasket 212 likewise comprises a slit so as to be able to receive pre-spliced wires therein.

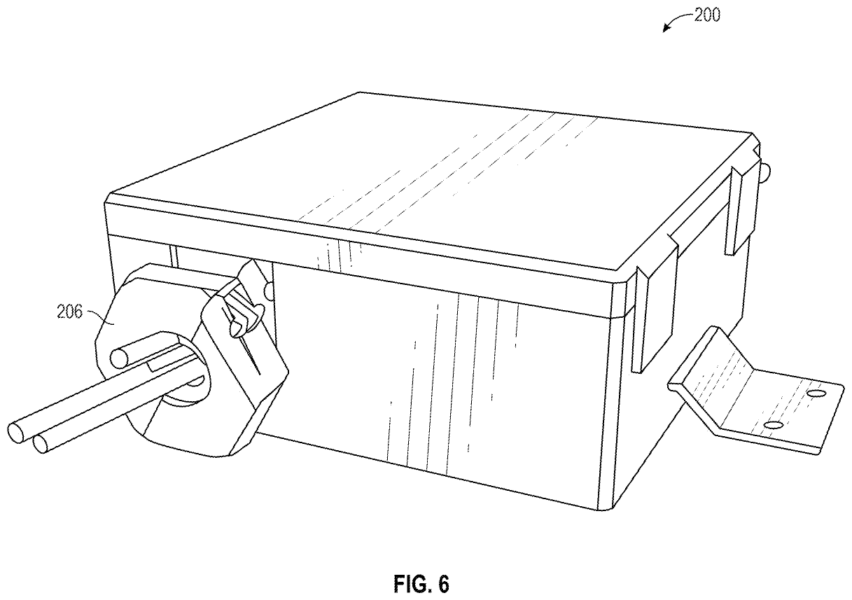

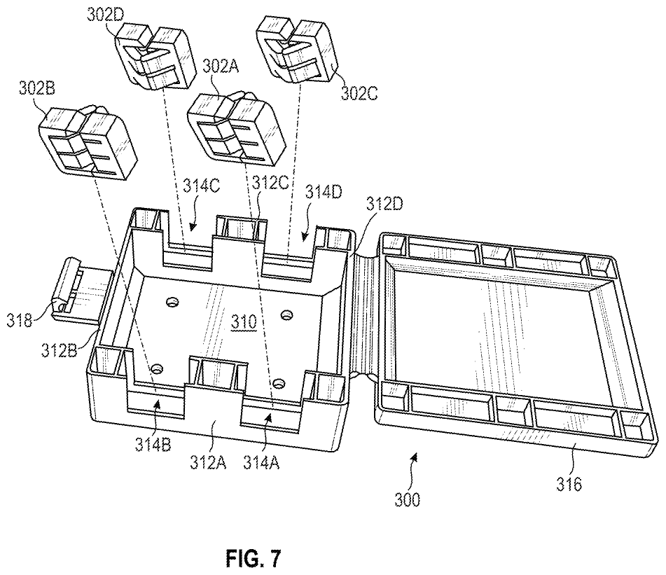

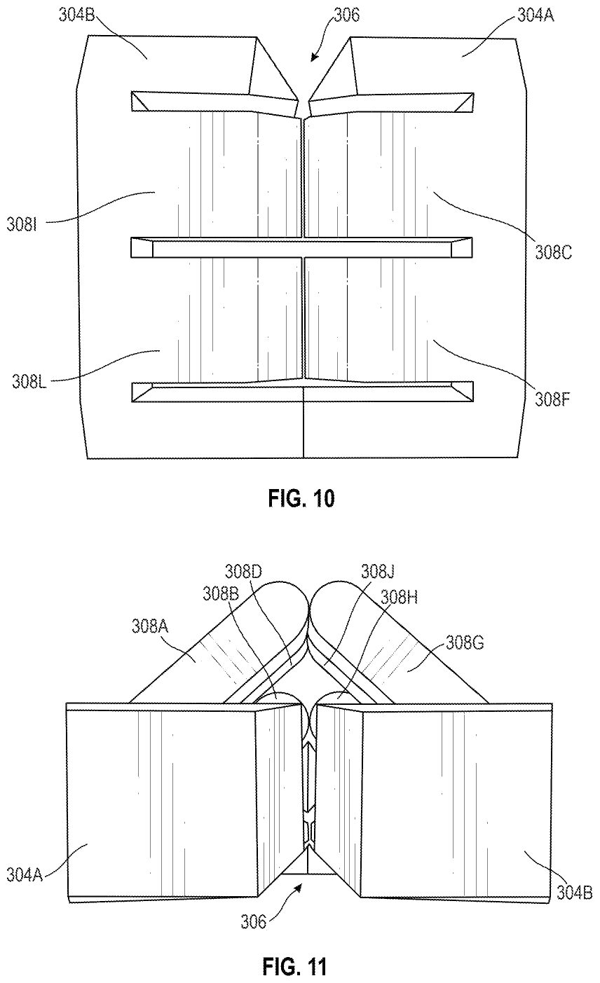

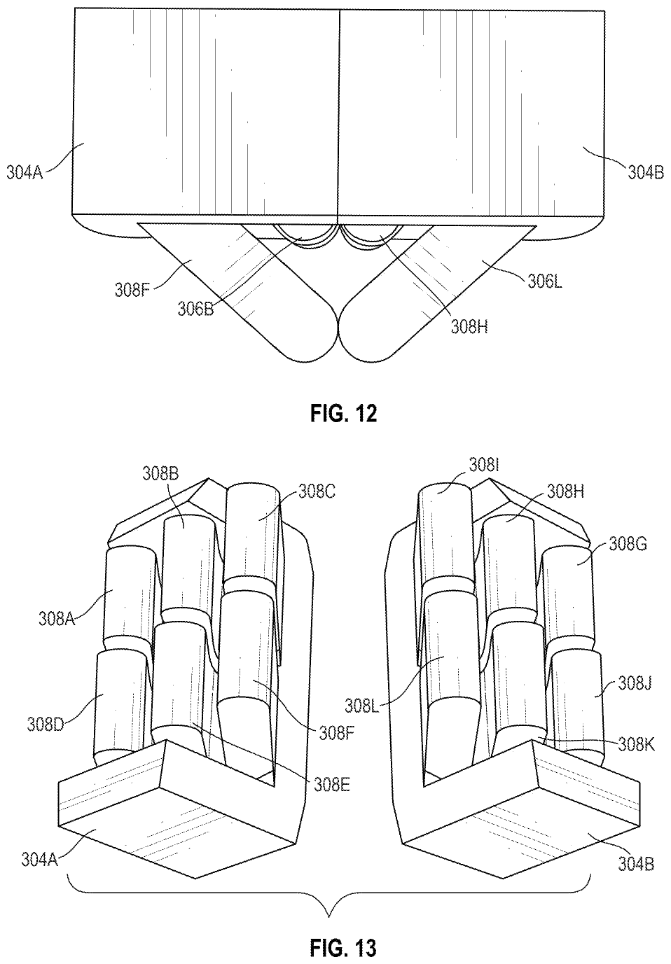

In some embodiments, as shown in FIGS. 7-13, an electrical wire housing 300 may comprise flexible members 302A-D configured to be received within a respective aperture 314A-D. Each of the flexible members 302A-D may comprise a first member 304A opposite a second member 304B, wherein a slit 306 either partially or entirely divides the first member 304A from the second member 304B. As best shown in FIG. 13, the first member 304A may comprise a first series of flexible protrusions 308A-F. Likewise, the second member 304B may comprise a second series of flexible protrusions 308G-L opposite the first series of flexible protrusions 308A-F. The first and second series of flexible protrusions 308A-L, as shown, are aligned perpendicular to the slit 306, as best seen in FIG. 11.

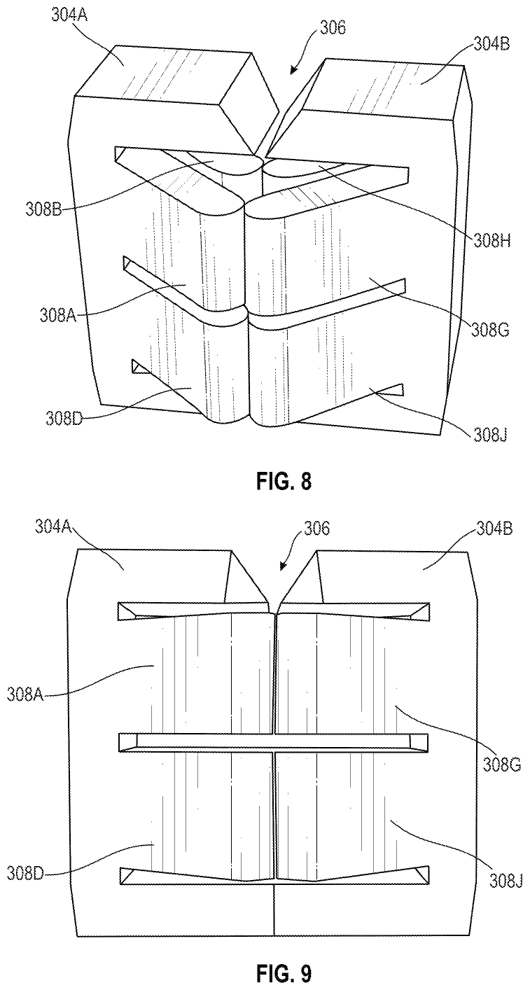

The first and second series of flexible protrusions 308A-F are configured with the first series of flexible protrusions 308A-F substantially oriented toward the second series of flexible protrusions 308G-L, as shown in FIGS. 8-12. Each assembly of a first member to a second member, such as first member 304A and second member 304B, is referred to as a flexible member, such as flexible member 302A. Flexible member 302A is then insertable into aperture 314A. The flexible protrusions of the first member 304A and the second member 304B are forced toward one another, maintaining contact with one another. A wire may then be forced down through the top via slit 306 and forced between the plurality of flexible protrusions 308A-L. Because the flexible protrusions 308A-L are angled toward the interior of the housing 300, the wire may be pulled toward the interior of the housing with the protrusions flexing inwardly away from one another, but is prevented from being withdrawn from the interior of the housing to the exterior of the housing due to the flexible protrusions abutting one another. In one non-limiting example, the amount of force required to pull a wire from inside the housing 300 to the outside should exceed 20 pounds of force.

Additionally, the first and second series of flexible protrusions 308A-L provide several water-resistant layers to inhibit the passage or water, debris, and other external elements through the slit 306 of the flexible members 302A-D into the electrical wire housing 300. It is contemplated that a lesser or greater number of flexible protrusions may be used within the first and second series of flexible members 308A-L to accomplish a range of strain relief, weatherproofing, and protection.

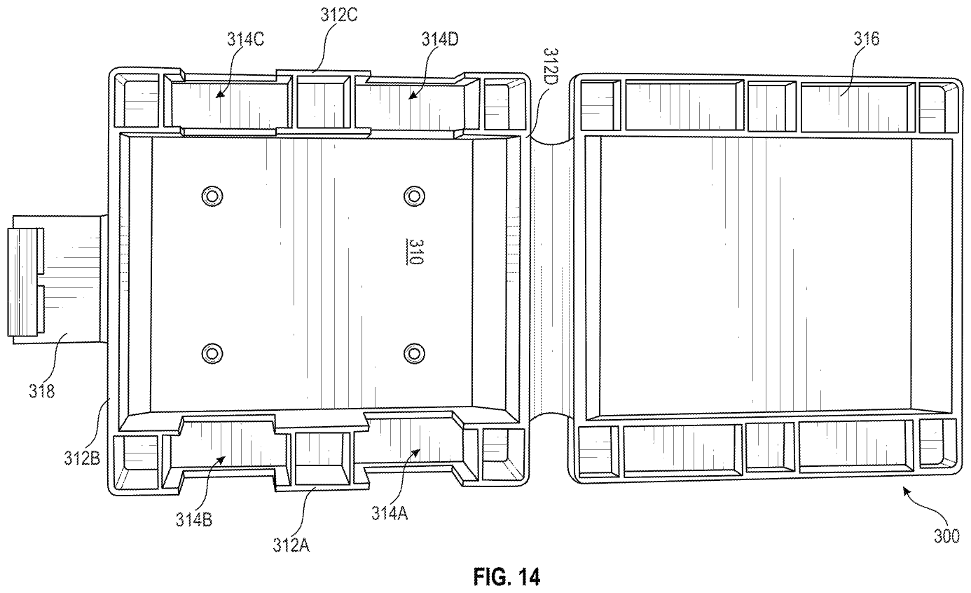

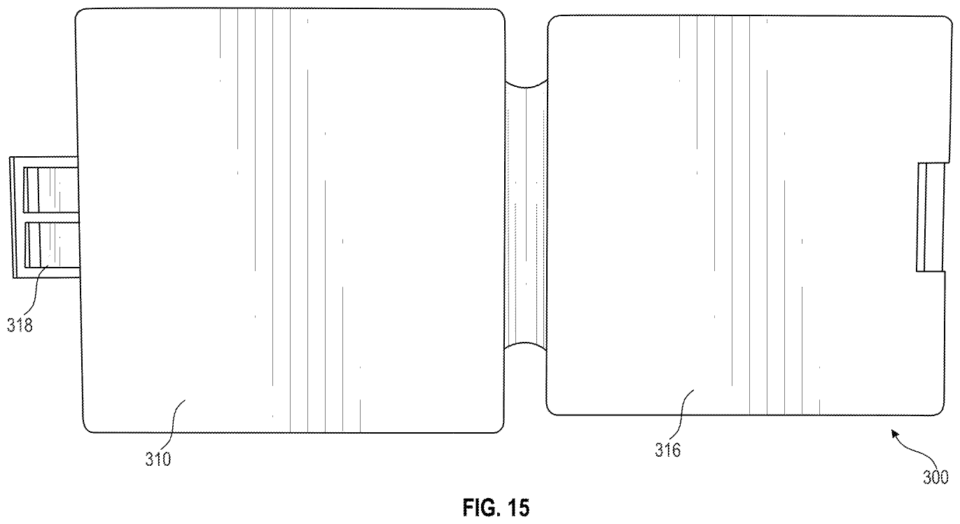

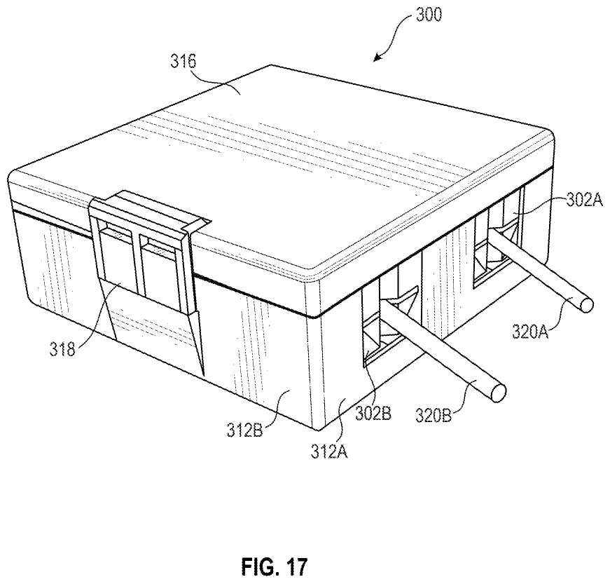

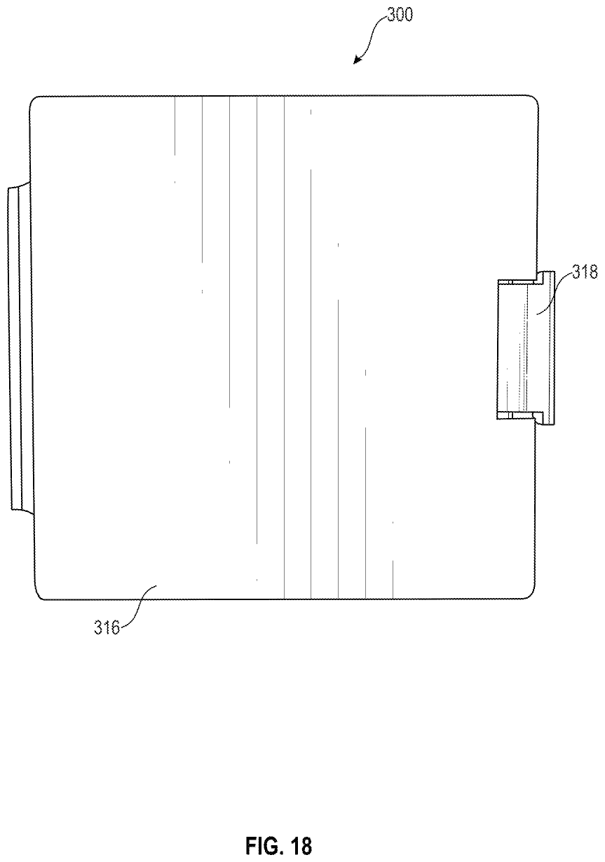

In some embodiments, as shown in FIGS. 14-18, the electrical wire housing 300 may comprise a base 310 coupled to four sidewalls 312A-D, wherein at least two sidewalls (e.g., 312A, 312C) each comprise one or more apertures 314A-D. The electrical wire housing 300 may further comprises a lid 316, which may be hingedly coupled to one of the sidewalls 312A-D and a bracket 318, clamp, or other locking mechanism to further secure the lid 316 to the electrical wire housing 300. The flexible members 302A-D may be couplable to the one or more apertures 314A-D within the four sidewalls 312A-D.

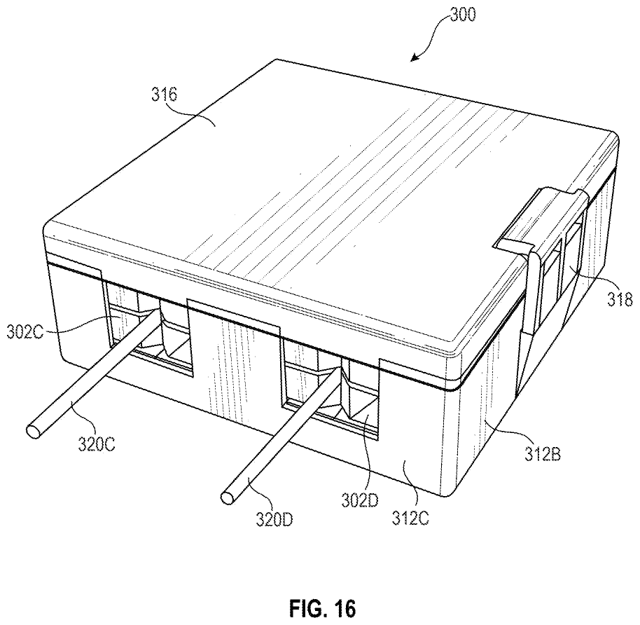

As shown in FIGS. 13-14, the electrical wire housing 300 may be opened and any splice connections made or inserted therein, as discussed earlier. As shown in FIGS. 16-18, the electrical wire housing 300 may thereafter be closed, safeguarding wires 320A-D and splice connections within from external elements and accidental contact with persons, animals, and things that could otherwise cause electrocution or fire hazards.

While the flexible members 110A-D, 302A-D and threaded couplers 202A-B are shown, it will be appreciated that other methods of securing the wires 108A-D, 320A-D in and through the sidewalls 104A-D, 312A-D may be achieved without departing herefrom. Therefore, it will be appreciated that the electrical wire housing 100, 200, 300 disclosed herein solves the need for a junction box that allows for wires to be connected either inside or outside of the box and that allows for pre-spliced wires to be safely secured in the box.

It will be appreciated that systems and methods according to certain embodiments of the present disclosure may include, incorporate, or otherwise comprise properties or features (e.g., components, members, elements, parts, and/or portions) described in other embodiments. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment unless so stated. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. An electrical wire housing, comprising:
a base;
four sidewalls, wherein at least two of the four sidewalls each comprise one or more apertures;
flexible members couplable to the one or more apertures, wherein each of the flexible members comprises a slit configured to enable a wire to pass through the slit; and
a lid couplable to the four side walls.

2. The electrical wire housing of claim 1, further comprising one or more aperture shields couplable to the one or more apertures.

3. The electrical wire housing of claim 1, further comprising wire securing protrusions.

4. The electrical wire housing of claim 1, wherein the flexible members comprise silicone.

5. The electrical wire housing of claim 1, wherein the flexible members are water resistant.

6. The electrical wire housing of claim 1, further comprising a bracket configured to secure the electrical wire housing to a structure.

7. The electrical wire housing of claim 1, wherein each flexible member comprises a first member opposite a second member, wherein each of the first and second members comprise at least one flexible protrusion.

8. The electrical wire housing of claim 7, wherein the at least one flexible protrusion of each first and second member is angled inwardly to the interior of the electrical wire housing.

9. An electrical wire housing, comprising:
a base;
four sidewalls, wherein at least two of the four sidewalls each comprise one or more apertures;
threaded couplers receivable within the one or more apertures; and
and a lid couplable to the four side walls.

10. The electrical wire housing of claim 9, wherein each of the threaded couplers comprises a male end couplable to a female end.

11. The electrical wire housing of claim 10, wherein the male end and female end each comprise a slit configured to open when pushed apart and thereafter close when pushed together, enabling a wire to be placed within each of the threaded couplers.

12. The electrical wire housing of claim 9, wherein the threaded couplers comprise a gasket between the male end and the female end.

13. The electrical wire housing of claim 9, wherein the threaded couplers are configured to enable electrical wires to be spliced outside the electrical wire housing and then placed within the electrical wire housing without decoupling the electrical wires.

14. The electrical wire housing of claim 9, further comprising one or more aperture shields couplable to the one or more apertures.

15. The electrical wire housing of claim 9, further comprising wire securing protrusions.

16. An electrical wire housing, comprising:
a base;
four sidewalls, wherein at least two of the four sidewalls each comprise one or more apertures;
flexible members couplable to the one or more apertures, wherein each of the flexible members further comprises:
a first series of flexible protrusions,
a second series of flexible protrusions opposite the first series of flexible protrusions,
a slit between the first series of flexible protrusions and the second series of flexible protrusions, configured to enable a wire to pass through the slit;
and a lid couplable to the four side walls.

17. The electrical wire housing of claim 16, further comprising one or more aperture shields couplable to the one or more apertures.

18. The electrical wire housing of claim 16, wherein the flexible members are water resistant.

19. The electrical wire housing of claim 16, further comprising a bracket configured to secure the electrical wire housing to a structure.

20. The electrical wire housing of claim 16, wherein the lid is hingedly coupled to one of the four sidewalls.
